(19) United States
(12) Patent Application Publication
(10) Pub. No.: US 2010/0332975 A1
(43) Pub. Date: Dec. 30, 2010

(54) AUTOMATIC MESSAGE MODERATION FOR MAILING LISTS

(75) Inventors: Jeffrey Albert Chang, Glenview, IL (US); Griffith Buckley Hazen, San Francisco, CA (US); Neil Christopher Jones, Sunnyvale, CA (US); Frank Pape, III, Endwell, NY (US); Eric Geoffrey Cattell, San Francisco, CA (US); Daniel Beckerley Fingal, San Francisco, CA (US); Gordon Leslie Rowell, Sydney (AU); Eric James DeFriez, Oakland, CA (US)

Correspondence Address: GOOGLE / FENWICK, SILICON VALLEY CENTER, 801 CALIFORNIA ST., MOUNTAIN VIEW, CA, 94041, US

(73) Assignee: GOOGLE INC., Mountain View, CA (US)

(21) Appl. No.: 12/491,918

(22) Filed: Jun. 25, 2009

(51) Int. Cl. G06F 15/16; G06F 17/24

(52) U.S. Cl. 715/256; 709/206

(57) ABSTRACT

Email messages in a mailing list for an organization are monitored and filtered (or queued for moderation) based on predetermined characteristics of the message. A manager of the mailing list can later determine whether the queued messages should be approved and distributed to the intended recipients or rejected and prevented from being distributed. Alternatively, an automatic decision is made to approve or reject messages based on the predetermined characteristics. The predetermined characteristics include: the size of the mailing list; the size of the email message; the existence of specified words (such as a product name or a specific word such as “confidential”) within the message; no subject line; the sender has sent too many messages already; and the email address matches a list.

### BACKGROUND

1. Field of Art

The disclosure generally relates to the online management of electronic mailing lists, and more specifically, to automatic email message moderation for mailing lists.

2. Description of the Related Art

Electronic mailing lists allow users to distribute email messages to a large number of subscribers of the mailing lists. Typically, one creates a mailing list by adding or inviting subscribers and becomes the owner and manager of that mailing list. There are various tools and on-line applications available that allow users to create such mailing lists, as well as manage access to and use of those mailing lists. These tools do not, however, generally make it easy enough for casual users to manage a list without significant training and disruption. Therefore, it is common for administrator-level users to create and manage mailing lists, even if they are not the people most directly involved in the subject matter of the mailing list. Particularly in corporate environments, a team leader, project manager, or the like who might otherwise be the most appropriate person to set up and manage a list may not have the time or the expertise in using existing mailing list tools, to properly set up, moderate and otherwise manage a list.

Once a mailing list is created, it becomes an on-line forum that can be used to share ideas and facilitate discussion. Typically, members of mailing lists are able to easily send messages to other members of the mailing list in order to communicate with one another. Consequently, ill-intended users can take advantage of this freedom and send unwanted or offensive messages to the entire mailing list. Additionally, careless users can send messages not appropriate for distribution. Moderation of the mailing list is an important aspect of managing the list, and ensures that the list remains as effective in achieving its purpose as possible. Therefore, a need remains for a system to facilitate the moderation and general management of mailing lists by regular users who are not trained list administrators and who do not have a great deal of time to devote to list management. A need also remains for an organization-specific mail list system that is both easy to use and ensures security of information disseminated using the system.

### SUMMARY

Email messages in a mailing list are monitored, filtered, or queued for moderation based on predetermined characteristics of the message. Messages queued for moderation are presented to a manager of the mailing list for approval and distribution or rejection. Alternatively, an automatic decision is made to approve or reject the message based on the predetermined characteristics. The predetermined characteristics include: the size of the mailing list; the size of the email message; the existence of specified words (such as “confidential” or a product trademark indicative of spam) within the message; no subject line; the sender has sent too many messages already; and the email address matches a predetermined list.

One embodiment includes a moderation system for a mailing list. The system includes a first computing subsystem adapted to receive a message from a client. The message is addressed to a plurality of addresses belonging to the mailing list. The system also includes a second computing subystem adapted to communicate with the first computing subsystem. The second computer subsystem is configured to examine a portion of the message and determine whether the portion passes a predetermined test. The system further includes a third computing subsystem adapted to communicate with the second computing system. The third computing system is adapted to mark the email message for processing. In one embodiment, the processing includes marking the message for moderation, and in other embodiments, the processing includes deleting the message.

Another embodiment includes a computer-implemented method for moderating a mailing list. The method includes receiving, by a first computing subsystem, an email message from a client wherein the message is addressed to a plurality of email addresses belonging to the mailing list. The method also includes examining, by a second computing subsystem, a portion of the email message and determining, by the second computing subsystem, whether the portion passes a predetermined test. The method further includes marking, by a third computing subsystem, the email message for processing. In one embodiment, the processing includes marking the message for moderation, and in other embodiments, the processing includes deleting the message.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 is a block diagram illustrating a system for automatic message moderation for mailing lists in accordance with one embodiment.

FIG. 2 is a block diagram illustrating a client device in accordance with one embodiment.

FIG. 3 is a block diagram illustrating a membership engine in accordance with one embodiment.

FIG. 4 is a block diagram illustrating a message moderation server in accordance with one embodiment.

FIG. 5 is a flow diagram illustrating a process for message moderation in accordance with one embodiment.

FIG. 6 is a flow diagram illustrating a process for message analysis in accordance with one embodiment.

FIG. 7 is an exemplary screenshot of a user interface for mailing list management in accordance with one embodiment.

FIG. 8 is an exemplary screenshot of a user profile in accordance with one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

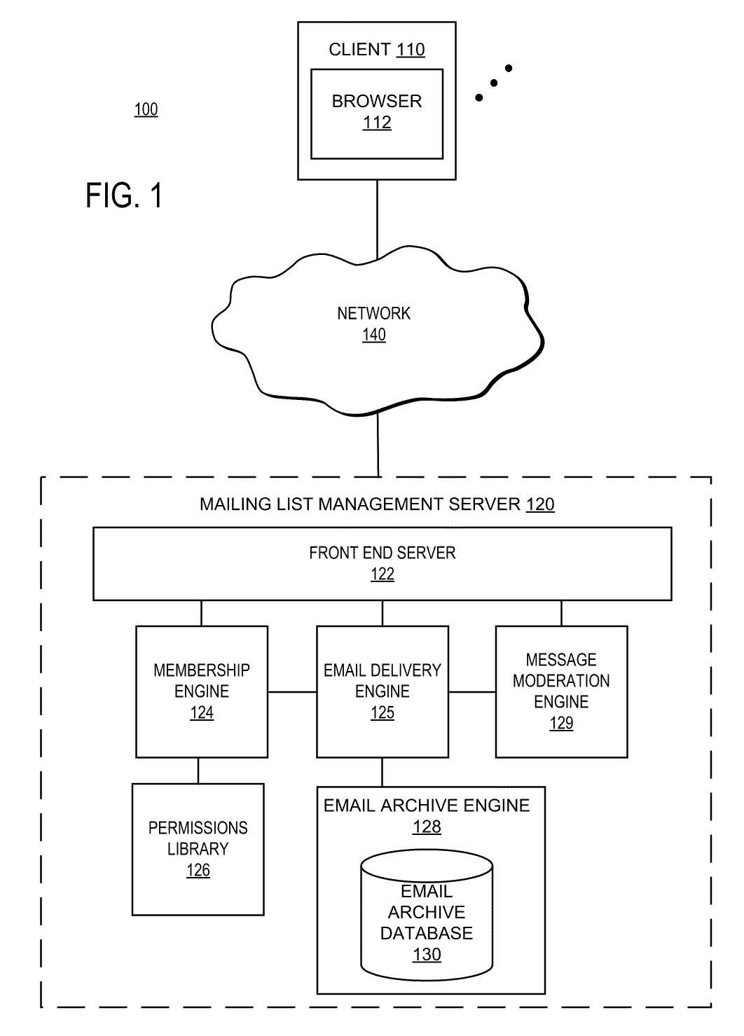

FIG. 1 is a block diagram illustrating a system 100 for automatic message moderation for mailing lists in accordance with one embodiment. The system 100 facilitates the online management of subscribers to a mailing list and also facilitates the distribution of email messages to the subscribers of the mailing lists. The system 100 includes one or more client devices 110, a network 140 and a mailing list management server 120. As shown in FIG. 1, the mailing list management server 120 includes a front end server 122, a membership engine 124, an email delivery engine 125, a permissions library 126, an email archive engine 128, and a message moderation engine 129. Many conventional features, such as firewalls, load balancers, application servers, failover servers, site management tools, and so forth are not shown so as not to obscure the features of the system. The functionality attributed to a particular server, engine or module can be performed by different or multiple servers, engines or modules operating together.

Each of the various servers is implemented as server program executing on server-class computer comprising a CPU, memory, network interface, peripheral interfaces, and other well known components. The computers themselves preferably run an open-source operating system such as LINUX, have generally high performance CPUs, 1 GB or more of memory, and 100 GB or more of disk storage. Of course, other types of computers can be used, and it is expected that as more powerful computers are developed in the future, they can be configured in accordance with the teachings here. The functionality implemented by any of the elements can be provided from computer program products that are stored in tangible computer accessible storage mediums (e.g., RAM, hard disk, or optical/magnetic media).

A client 110 executes a browser 112 and connects to the front end server 122 via the network 140, which is typically the Internet, but may also be any network, including but not limited to any combination of a LAN, a MAN, a WAN, a mobile, wired or wireless network, a private network, or a virtual private network. While only a single client 110 and browser 112 are shown, it is understood that very large numbers (e.g., millions) of clients are supported and can be in communication with the system 100 at any time. In one embodiment, the browser 112 is used to access a website for management of mailing lists. A suitable website for implementation of the system 100 is the GOOGLE GROUPS™ website, found at http://groups.google.com/; other mailing list management websites are known as well, and can be adapted to operate according the teaching disclosed herein.

The network 140 enables communications between the client 110 and the mailing list management server 120. In one embodiment, the network 140 uses standard communications technologies and/or protocols. Thus, the network 140 includes links using technologies such as Ethernet, 802.11, integrated services digital network (ISDN), digital subscriber line (DSL), asynchronous transfer mode (ATM), InfiniBand, PCI Express Advanced Switching, etc. Similarly, the networking protocols used on the network 140 include in various embodiments multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 140 is represented using conventional technologies and/or formats including the hypertext markup language (HTML), the extensible markup language (XML), etc. In addition, all or some of links in some embodiments are encrypted using conventional encryption technologies such as the secure sockets layer (SSL), Secure HTTP and/or virtual private networks (VPNs) or Internet Protocol security (IPsec). In other embodiments, the entities use custom and/or dedicated data communications technologies instead of, or in addition to, the ones described above. Depending upon the embodiment, the network 140 also includes links to other networks such as the Internet.

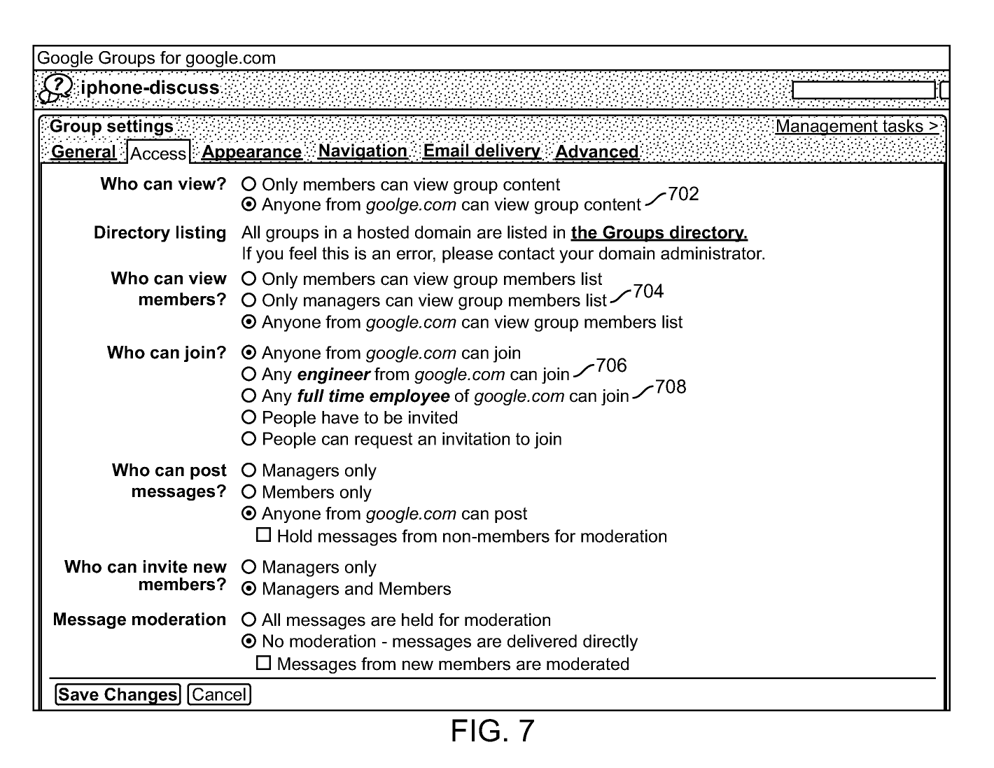

The front end server 122 provides a user interface for mailing list management as well as message viewing and composing. The front end server 122 is adapted to communicate with clients 110 via the network 140 and is also adapted to communicate with the membership engine 124, email delivery engine 125 and message moderation engine 129. The front end server 122 receives composed messages and other mailing list task requests from clients 110 and communicates with the membership engine 124, email delivery engine 125 and message moderation engine 129 to take appropriate action with the composed message or perform the appropriate task. The front end server 122 facilitates convenient management and modification of mailing lists by providing a user interface for mailing list administration. The front end server 122 is adapted to communicate with the membership engine 124 in order to retrieve membership information to be displayed on the user interface. The user interface is displayed on the web browser 112 of the client 110 and users can easily access membership information, as well as other information related to the mailing list, via the user interface. An exemplary screenshot of the user interface is shown in FIG. 7, the description of which is provided in further detail below.

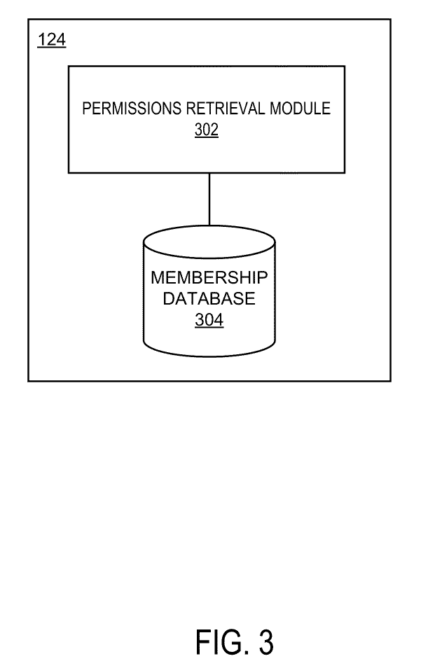

The membership engine 124 stores membership information for various mailing lists. The membership engine 124 is coupled for communication with the permissions library 126 and retrieves permission information from the permissions library 126. As shown in FIG. 3, the membership engine 124 includes a permissions retrieval module 302 for retrieving permissions information form the permissions library 126 and a membership database 304 for storing membership information. Membership information for various mailing lists includes email addresses of users belonging to the mailing list. In some embodiments, membership information includes a name and/or other identifying information associated with each email address. In some embodiments, membership information also includes permission levels, mailing list associations, an employee title, email delivery preferences, a membership date, and a membership type associated with each user. In one embodiment, the membership engine 124 also stores identifying information associated with users who have been invited to join the mailing list, but have not yet confirmed membership. In some embodiments, the membership engine 124 also stores identifying information associated with users who are banned from the mailing list. In other embodiments, the membership engine 124 stores other information associated with each user, such as information associated with a user ID, the user's login information or credentials, the user's residential location, the user's email address, a username, the user's country of residence, the user's date of birth, the user's gender, identifying information of other mailing lists of which the user is a member, as well as additional information related to the particular user. In one embodiment, the membership engine 124 stores all of the aforementioned information, and in other embodiments, the membership engine stores only some of the aforementioned information.

Turning back to FIG. 1, the email delivery engine 125 of the system 100 facilitates the sending and receiving of email messages to and from clients 110 of the system 100. The email delivery engine 125 is adapted for communication with the front end server 122 and the email archive engine 128. In one embodiment, the email delivery engine 125 uses the Simple Mail Transfer Protocol (SMTP) to send email messages to a local mail transfer agent (MTA), typically run by a user's Internet Service Provider (ISP). In other embodiments, the email delivery engine 125 uses another email transfer mechanism to deliver email messages to and from clients 110 in the system 100.

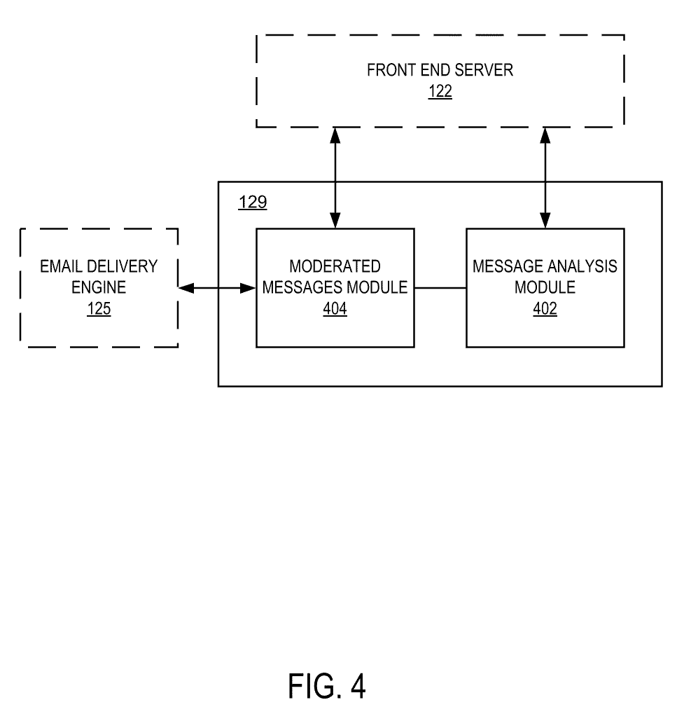

The message moderation engine 129 facilitates the automatic moderation of email messages being distributed to the mailing lists. The message moderation engine 129 is adapted for communication with the front end server 122 and the email delivery engine 125. In one embodiment, the message moderation engine 129 is adapted to receive composed email messages from the front end server 122 and route approved email messages for delivery to the email delivery engine 125. The message moderation engine 129 examines the content and characteristics of email messages to determine whether the email message should first be moderated by the mailing list owner before being distributed and marks the email message for later approval or rejection by the mailing list owner. More detail concerning the components and functionality of the message moderation engine 129 is provided below with reference to FIGS. 4-6.

The permissions library 126 provides permission information to the message moderation system 100. The permissions library 126 is adapted to communicate with the membership engine 124 and provide permission information for members of the mailing lists. The permissions library 126 includes permission information for members of mailing lists. The permissions library 126 stores the email addresses of members of the mailing lists, and for each email address, the permissions library 126 stores the associated mailing lists and the levels of access associated with the email address for each mailing list. In one embodiment, the permissions library 126 considers a group of users as an individual entity for purposes of determining and managing permissions. Thus, if a new user joins a group, that user automatically gets permissions based on membership in the group. In some embodiments, the permissions library 126 also stores permission information for other applications, systems or websites with access to the permissions library 126 and acts as a central repository for permissions information for email addresses and groups stored in the permissions library 126. For example, in some embodiments, the users associated with the email addresses stored in the permissions library 126 may also be members of other systems or websites, such as those used for photo sharing, document editing and social networking. In such embodiments, the permissions library 126 stores permissions information for these members of the photo sharing websites and in other embodiments, the permissions library 126 stores permissions information for the members with access to the document editing website. Again, by considering a group as an entity, permissions library 126 is able to pass permission information to other systems on a group basis, as well as on an individual basis.

The email archive engine 128 stores email messages sent to members of the mailing lists. The email archive engine 128 is adapted to communicate with the email delivery engine 125, receives email messages that are sent to members of the mailing lists and sends the email messages to an email archive database 130 to be stored therein. In one embodiment, the email archive engine 128 stores all email messages sent to members of the mailing list. In another embodiment, the email delivery engine 125 retrieves stored email messages from the email archive engine 128, for instance in order to provide a “digest version” of all messages received in one day. In some embodiments, the email archive engine 128 includes an indexing system and a search system (not shown) for indexing and searching the stored emails. In such embodiments, the email archive engine 128 also includes a front end server (not shown) for receiving search queries from a user of the client 110 and provides the search queries to the search system of the email archive engine 128.

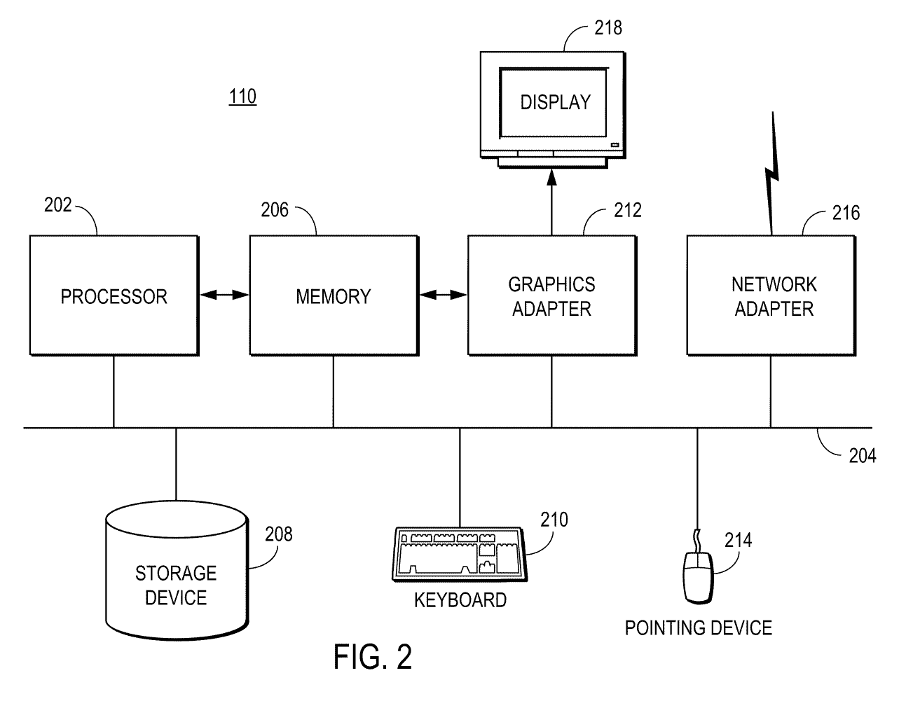

FIG. 2 is a block diagram illustrating the main components of client 110 in accordance with one embodiment. Illustrated are at least one processor 202 coupled to a bus 204. Also coupled to the bus 204 are a memory 206, a storage device 208, a keyboard 210, a graphics adapter 212, a pointing device 214, and a network adapter 216. In one embodiment, the functionality of the bus 204 is provided by an interconnecting chipset. A display 218 is coupled to the graphics adapter 212.

The storage device 208 is any device capable of holding data, such as a hard drive, compact disk read-only memory (CD-ROM), DVD, or solid-state memory device. The memory 206 holds instructions and data used by the processor 202. The pointing device 214 may be a mouse, track ball, or other type of pointing device, and is used in combination with the keyboard 210 to input data into the computer system 200. The graphics adapter 212 displays images and other information on the display 218. The network adapter 216 couples the computer system 200 to a local or wide area network.

As is known in the art, the client 110 can have different and/or other components than those shown in FIG. 2. In addition, in certain embodiments and applications, the client 110 can lack certain illustrated components such as keyboard 210, pointing device 214, graphics adapter 212, and/or display 218. Moreover, the storage device 208 can be local and/or remote from the client 110, such as embodied within a storage area network (SAN).

As is known in the art, client 110 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 208, loaded into the memory 206, and executed by the processor 202.

Now turning to FIG. 4, a block diagram illustrating the message moderation engine 129 in accordance with one embodiment is shown. The message moderation engine 129 includes a message analysis module 402 and a moderated messaged module 404 and is adapted to communicate with the front end server 122 and the email delivery engine 125. The message moderation engine 129 receives composed email messages from the front end server 122 and analyzes the email messages via the message analysis module 402 of the message moderation engine 129. The analyzed email messages that are queued for moderation are stored in the moderated messages module 404 and are later routed to the email delivery engine 125 for delivery. The front end server 122 retrieves stored messages that are queued for moderation and displays those messages on the browser 112 of the client 110 so that the manager of the mailing list can approve or reject the queued messages.

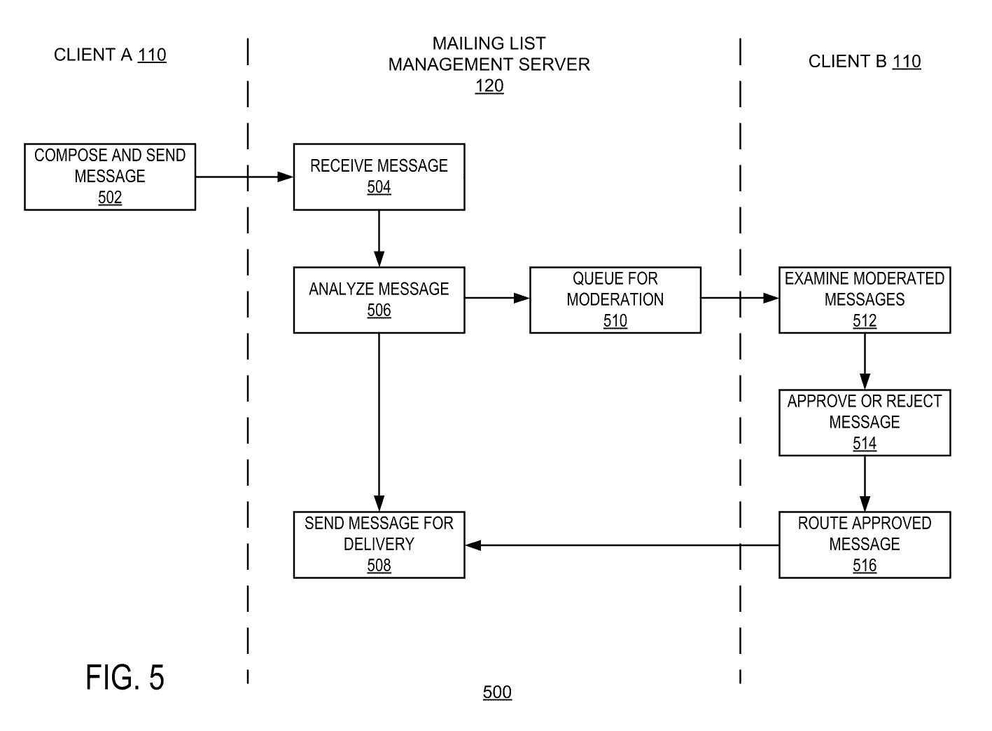

FIG. 5 is a flow diagram illustrating a process 500 for message moderation in accordance with one embodiment. The process 500 begins when an email message is composed and sent 502 to a mailing list via the browser 112 of a client 110. The email message is received 504 at the front end server 122 of the mailing list management server 120. The message passes to the message moderation engine 129 of the mailing list management server 120 and is analyzed 506 to determine whether the message should be delivered to the intended recipients or queued for moderation. If an email message is queued for moderation, the email message must first be approved before the email message is delivered to the intended recipients. In one embodiment, the message is analyzed 506 to determine whether the message should be delivered to the intended recipients or be automatically rejected. In some embodiments, a rejected message is automatically deleted. In other embodiments, a rejected message is stored in the moderated messages module 404 and not routed to the email delivery engine 125 for delivery.

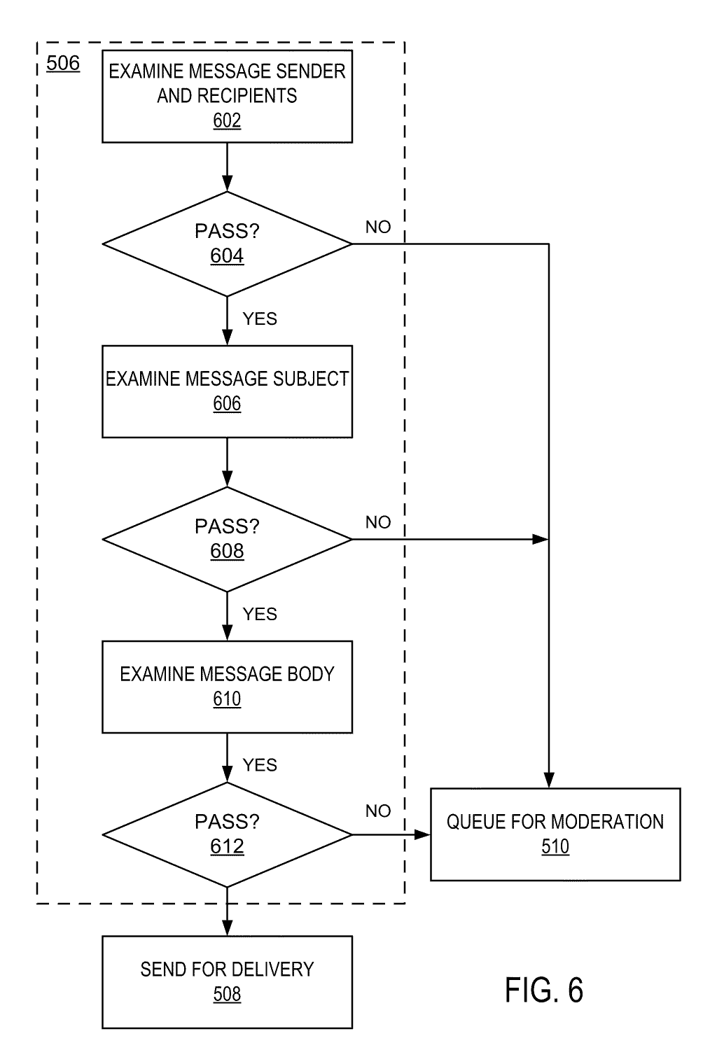

FIG. 6 is a flow diagram illustrating a process for message analysis 506 in accordance with one embodiment. The message analysis module 402 of the message moderation engine 129 examines various characteristics of the email message in order to determine whether the message should be queued for moderation or automatically rejected. In accordance with one embodiment, the message analysis module 402 of the message moderation engine 129 examines 602 the email addresses of the sender and recipients of the email message. In one embodiment, a determination 604 is made as to whether the examination of the recipients passes a predetermined test. In one embodiment, the predetermined test is based on the total number of intended recipients in the mailing list who have been sent a message from this sender in a particular period of time. If the total number of recipients exceeds a predetermined threshold (e.g., 100 recipients per day from this sender), then the test is not passed (604—No) and the message is sent to the moderated message module 404 and queued 510 for moderation or automatically rejected. If the total number of recipients does not exceed a predetermined number, then the test is passed (604—Yes), and the process 506 continues. In other embodiments, a similar test looks to the number of members of a list and queues a message for moderation if the number of members exceeds a threshold. In another embodiment, the predetermined test is based on the email address of the sender of the message. In such embodiments, the email address of the sender of the message is compared to a list of email addresses that are banned from distributing messages to particular mailing lists. If the email address of the sender appears on the list, then the test is not passed (604—No) and the message is sent to the moderated message module 404 and queued 510 for moderation or automatically rejected. If the email address of the sender of the email message does not appear on the list, then the test is passed (604—Yes), and the process 506 continues.

The message analysis module 402 of the message moderation engine 129 also examines 606 the content of the subject of the message. A determination 608 is made as to whether the examination of the subject of the email message passes a predetermined test. In one embodiment, the predetermined test is based on whether the message contains a subject. If the message does not contain a subject, then the test is not passed (608—No) and the message is sent to the moderated messages module 404 and queued 510 for moderation. If the message contains a subject, then the test is passed (608—Yes) and the process 506 continues. In another embodiment, the predetermined test is based on whether the subject of the message contains certain specified words. In such embodiments, the words of the subject of the message are compared to a list of specified words and if the subject of the email message includes words in the list, then the test is not passed (608—No) and the message is sent to the moderated messages module 404 and queued 510 for moderation. For example, the if subject of the email message contains misspelled words, profane or offensive words, or words that may signal that the message is confidential, the message manager of the mailing list may not want the message to be distributed to the intended recipients and therefore, the message does not pass the test (608—No) and the message is sent to the moderated messages module 404 and queued 510 for moderation. If the message does not contain words in the list, the message passes the test (608—Yes) and the process 506 continues.

The message analysis module 402 of the message moderation engine 129 also examines 610 the content of the body of the email message and attachments, if any. A determination 612 is made as to whether the examination of the content of the body of the email message passes a predetermined test. In one embodiment, the predetermined test is based on whether the body of the message contains any content. If the body of the message contains no content, then the sender may not have intended for the email message to be sent. If the body of the email message does not contain any content, then the test is not passed (612—No) and the message is sent to the moderated messages module 404 and queued 510 for moderation. If the body of the message contains content, then the test is passed (612—Yes) and the process 506 continues. In another embodiment, the predetermined test is based on whether the body of the email message contains certain specified words. In such embodiments, the words of the body of the message are compared to a list of specified words and if the body of the email message includes words in the list, then the test is not passed (612—No) and the message is sent to the moderated messages module 404 and queued 510 for moderation. For example, if the body of the email message contains misspelled words, profane or offensive words, or words that may signal that the message is confidential, the message manager of the mailing list may not want the message to be distributed to the intended recipients and therefore, the message does not pass the test (612—No) and the message is sent to the moderated messages module 404 and queued 510 for moderation. If the message does not contain words in the list, the message passes the test (612—Yes) and the process 506 continues. In yet another embodiment, the predetermined test is based on the overall size of the message (including attachments, e.g., 5 Megabytes); in alternate embodiments, a test is also made as to the number of words in the body of the email message. In such embodiments, an analysis is performed to determine whether the size of the message exceeds a predetermined threshold. If so, then the test is not passed (612—No) and the message is sent to the moderated messages module 404 and queued 510 for moderation. If the message does not exceed the predetermined threshold, then the test is passed (612—Yes) and the process 506 continues. In yet other embodiments, an analysis is performed to determine whether the body of the email message contains many repeating words or particular patterns. Such characteristics may signal that the message is spam or non-substantive content. If the body of the message contains a number of repeating words or patterns greater than a predetermined threshold, then the test is not passed (612—No) and the message is sent to the moderated messages module 404 and queued 510 for moderation. If the body of the message does not contain a number of repeating words greater than a predetermined threshold, then the test is passed (612—Yes) and the process 506 continues.

In one embodiment, one of the aforementioned tests is performed on the email message to determine if the message should be queued 510 for moderation, automatically rejected or sent to the email delivery engine 125 for delivery to the intended recipients. In other embodiments, a combination of some of the tests are performed, and in yet other embodiments, all of the tests are performed to determine if the message should be queued for moderation, automatically rejected or sent to the email delivery engine 125 for delivery to the intended recipients. In some embodiments, if the email message is queued for moderation or automatically rejected, the moderated messages module 404 creates a notification and sends the notification to the message sender via the email delivery engine 125. In each instance, the tests provide a reasonably simply manner for queuing certain messages for moderation while allowing others to be sent without moderation, thereby reducing the burden on the person moderating the list from what would be required if all messages were submitted for moderation.

Returning to FIG. 5, after the analysis 506, if the test is passed, the message is sent 508 to the email delivery engine 125 to be delivered to the intended recipients. If the message does not pass one or more of the aforementioned tests, the message is sent to the message moderation module 404 and queued 510 for moderation.

Once the messages are queued for moderation, the moderated messages are examined 512 at a client B 100. If the message is approved 514, the message is routed 516 for delivery by the email delivery engine 125. In one embodiment, if the message is rejected 514, the message is automatically deleted (not shown). In another embodiment, if the message is rejected 514, the message is stored and not routed to the email deliver engine 125 for delivery.

FIG. 7 is an exemplary screenshot of a user interface 700 for mailing list management in accordance with one embodiment. The user interface 700 allows mailing list managers to modify access control for the mailing list. In one embodiment, the access to the mailing list is accessible to email addresses with a certain domain name. In another embodiment, access to the mailing list is accessible to email addresses identified as being a part of a certain subgroup. As shown in FIG. 7, option 702 is selected to limit discussion viewing access to those users with a “company.com” email address. Also shown in FIG. 7, option 704 is selected to limit mailing list membership viewing access to those users with a “company.com” email address.

In another embodiment, members are identified as belonging to a certain category. In some embodiments, the category is based on employment status within a company. In other embodiments, the category is based on a person's title or job description within a company. In yet other embodiments, the category may be based on any other characteristics that can be used to distinguish a certain group of members from other members. As shown in FIG. 7, in such embodiments, option 706 is selected to limit access to users identified as “engineers” and option 708 is selected to limit access to users identified as “full time employees.”

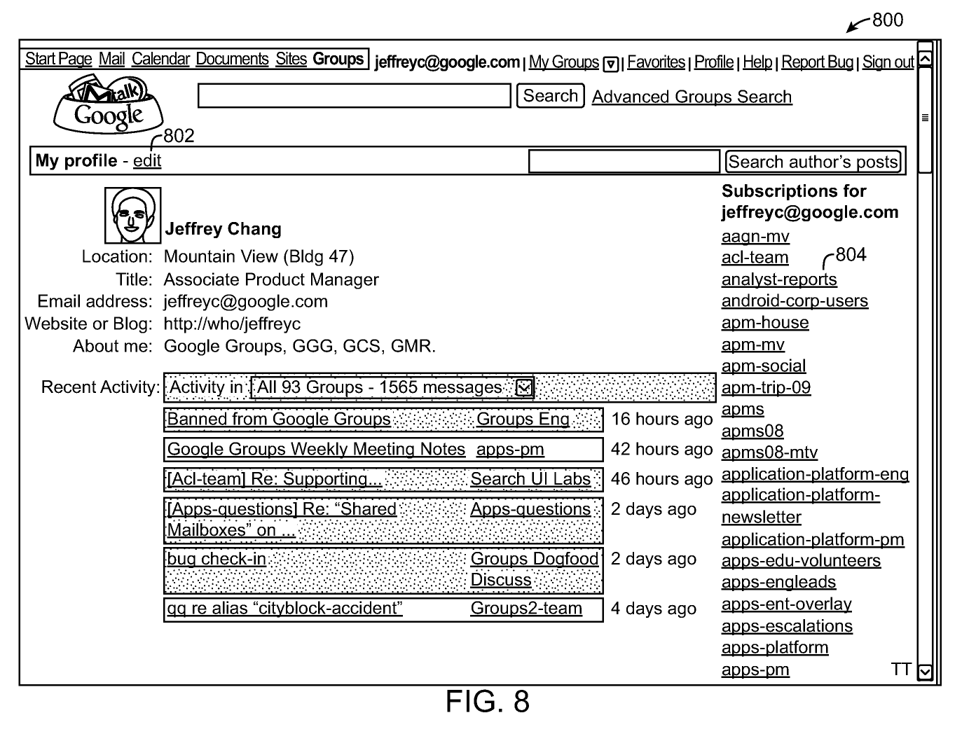

Mail list users in an organizational (e.g., corporate) environment differ from mail list users in the general public in a number of ways. Typically, corporations create many more functional groupings of personnel than people create in their personal lives. Accordingly, corporate mail users may expect to be in a larger number of groups than users of a public mailing list. Furthermore, in most organizations there is not the same expectation of privacy concerning such groupings as may exist in other environments, i.e., one would expect that engineers will have visibility into the groups to which their colleagues belong. Referring now to FIG. 8, in one embodiment these characteristics of organizational environments is used to increase mailing list effectiveness. Specifically, a user interface 800 includes a user profile 802 for an employee. In an employment context, it may be appropriate to allow, for instance, peer-level colleagues of an employee to see on the employee's profile interface 800 the various mailing lists 804 to which the employee subscribes. As is evident from FIG. 8, in some corporate environments employees may subscribe to dozens, if not hundreds, of highly focused groups. By providing peers with access to the groups to which other employees belong, peers can very quickly determine additional groups to which they may wish to subscribe.

Given an environment populated by a large number of groups, increasing efficiency of mailing list administration by focusing on groups rather than individuals is highly beneficial.

Another distinguishing aspect of corporate environments compared with public environments is that the common corporate domain provides a very simple yet effective limitation on access. Thus, a first filter for whether users are permitted access to a list is simply that they have addresses in the corporate domain (e.g., employee@company.com). As noted above in connection with FIG. 7, such common domain as well as job descriptions (e.g., engineer) are usable to provide straightforward control over who may subscribe to a list.

Embodiments of the systems and methods described herein can include other and/or different modules than the ones described here. In addition, the functionality attributed to the modules can be performed by other or different modules in other embodiments. Moreover, this description occasionally omits the term “module” for purposes of clarity and convenience. In some embodiment, the modules include processors, subsystems, or processor subsystems for performing various tasks and enabling various functionalities and the actions performed by the modules are enabled or performed by the processors, subsystems, or processor subsystems.

Some portions of above description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for message moderation for mailing lists through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A moderation system for a mailing list, comprising:
a first computing subsystem adapted to receive a message from a client, wherein the message is addressed to a plurality of addresses belonging to the mailing list;
a second computing subsystem, adapted to communicate with the first computing subsystem, the second computing subsystem being configured to examine the message and determine whether the message passes a predetermined test; and
a third computing subsystem, adapted to communicate with the second computing system, the third computing system adapted to mark the email message for no moderation responsive to the message passing the predetermined test and for moderation responsive to the portion not passing the predetermined test.

2. The system of claim 1, wherein the message includes a subject and the predetermined test is based on whether the subject contains content.

3. The system of claim 1, wherein the message includes a subject and the predetermined test is based on whether the subject contains a specified word.

4. The system of claim 1, wherein the message includes a subject and the predetermined test is based on whether the subject contains misspelled words.

5. The system of claim 1, wherein the message includes a body and the predetermined test is based on whether the body contains content.

6. The system of claim 1, wherein the message includes a body and the predetermined test is based on whether the body contains a specified word.

7. The system of claim 1, wherein the message includes a body and the predetermined test is based on whether the body contains many repeating words.

8. The system of claim 1, wherein the message includes a body and the predetermined test is based on whether the body contains misspelled words.

9. The system of claim 1, wherein the message includes a number of email addresses and the predetermined test is based on whether the number exceeds a threshold.

10. The system of claim 1, wherein the message includes identification of a sender and the predetermined test is based on whether the sender is included in a predefined list.

11. The system of claim 1, wherein the message includes identification of a sender and the predetermined test is based on a number of recipients to whom the sender has sent messages in a given period of time.

12. The system of claim 1, wherein the message has an overall size and the predetermined test is based on the overall size.

13. The system of claim 1, wherein moderation includes queuing the message for review.

14. The system of claim 1, wherein moderation includes deleting the message.

15. A mailing list system for an organization, comprising:
a membership computing subsystem adapted to receive a request from a user to join a mailing list and to generate an approval of the request responsive to the user having at least one of: an address within a domain of the organization and a position in the organization approved for membership in the mailing list; and
a permissions computing subsystem adapted to inform the membership computing subsystem as to whether the position is approved for membership in the mailing list.

16. The system of claim 15, further comprising a first interface subsystem for a moderator producing membership qualification controls for the mailing list and a second interface subsystem producing profiles for display to members of the mailing list.

17. The system of claim 15, wherein the permissions computing subsystem is further adapted to manage permissions on a group basis.

18. A computer-implemented method for moderating a mailing list, comprising:
receiving, by a first computing subsystem, a message from a client, wherein the message is addressed to a plurality of addresses belonging to the mailing list;
examining, by a second computing subsystem, the message;
determining, by the second computing subsystem, whether the message passes a predetermined test; and
marking, by a third computing subsystem, the message for no moderation responsive to the message passing the predetermined test and for moderation responsive to the message not passing the predetermined test.

19. The computer-implemented method of claim 18, wherein the message includes a subject and the predetermined test is based on whether the subject contains content.

20. The computer-implemented method of claim 18, wherein the message includes a subject and the predetermined test is based on whether the subject contains a specified word.

21. The computer-implemented method of claim 18, wherein the message includes a subject and the predetermined test is based on whether the subject contains misspelled words.

22. The computer-implemented method of claim 18, wherein the message includes a body and the predetermined test is based on whether the body contains content.

23. The computer-implemented method of claim 18, wherein the message includes a body and the predetermined test is based on whether the body contains a specified word.

24. The computer-implemented method of claim 18, wherein the message includes a body and the predetermined test is based on whether the body contains many repeating words.

25. The computer-implemented method of claim 18, wherein the message includes a body and the predetermined test is based on whether the body contains misspelled words.

26. The computer-implemented method of claim 18, wherein the message includes a number of email addresses and the predetermined test is based on whether the number exceeds a threshold.

27. The computer-implemented method of claim 18, wherein the message includes identification of a sender and the predetermined test is based on whether the sender is included in a predefined list.

28. The computer-implemented method of claim 18, wherein the message includes identification of a sender and the predetermined test is based on a number of recipients to whom the sender has sent messages in a given period of time.

29. The computer-implemented method of claim 18, wherein the message has an overall size and the predetermined test is based on the overall size.

30. The computer-implemented method of claim 18, wherein moderation includes queuing the message for review.

31. The computer-implemented method of claim 18, wherein moderation includes deleting the message.

32. A computer-implemented method of providing a mailing list for an organization, comprising:
receiving, by a membership computing subsystem, a request from a user to join a mailing list and to generate an approval of the request responsive to the user having at least one of: an address within a domain of the organization and a position in the organization approved for membership in the mailing list; and
informing the membership computing subsystem, by a permissions computing subsystem, as to whether the position is approved for membership in the mailing list.

33. The computer-implemented method of claim 32, further comprising providing membership qualification controls for the mailing list for use by a moderator, and providing profiles for display to members of the mailing list.

34. The system of claim 32, further comprising managing permissions on a group basis.
